(19) United States
(12) Patent Application Publication
(10) Pub. No.: US 2025/0385610 A1
(43) Pub. Date: Dec. 18, 2025

(54) DC-DC CONVERTER

(71) Applicant: Continental Automotive Technologies GmbH, Hannover (DE)

(72) Inventors: Emil Kovatchev, Wien (AT); Florian Friedrich, Wien (AT); Christian Stöger, Wien (AT)

(73) Assignee: Continental Automotive Technologies GmbH, Hannover (DE)

(21) Appl. No.: 19/238,720

(22) Filed: Jun. 16, 2025

(30) Foreign Application Priority Data
Jun. 17, 2024 (DE) 10 2024 205 591.3
Mar. 21, 2025 (DE) 10 2025 110 978.8

(51) Int. Cl. H02M 3/158; H02M 1/00; H02M 3/00

(52) U.S. Cl. CPC H02M 3/1588; H02M 1/0058; H02M 3/01

(57) ABSTRACT

A DC-DC converter in the form of a ZVS boost or ZVS buck converter includes a storage transistor is connected in series with a resonant coil and in parallel with a resonant capacitor, whereby an M-type switch is formed. A synchronous rectifier transistor is used as a freewheel element, which is controlled by the resonant voltage at a connection terminal between the resonant coil and the resonant capacitor. For this purpose, the resonant connection terminal is connected to the control terminal of the synchronous rectifier transistor via a voltage divider with signal-shaping components.

### CROSS-REFERENCE TO RELATED APPLICATIONS

This application claims priority to German patent application No. 10 2024 205 591.3, filed Jun. 17, 2024, and German patent application No. 10 2025 110 978.8, filed Mar. 21, 2025, each of which is hereby incorporated by reference.

### TECHNICAL FIELD

The technical field relates generally to DC-DC converters.

### BACKGROUND

DC-DC converters in the form of step-up voltage converters (also known as boost converters) and step-down voltage converters (or buck converters) require at least two switching elements, often implemented in the form of a MOSFET and a diode or two MOSFETs, one of which takes over the rectifier or freewheeling role, and are usually operated in the so-called “hard-switching” mode. This means that the control logic forces the switching elements to switch at a moment when the current and/or the voltage through or at the switch is not equal to zero. This causes switching losses, which occur in the form of the area below the current and voltage curves during the switching process, averaged over the switching period.

The so-called ZVS (zero voltage switching) and ZCS (zero current switching) converter topologies can be synthesized by the targeted use of additional reactances in the form of a resonant choke and a resonant capacitor. The advantage here is that at least one of the switching operations, optionally switching on or off, can be performed without loss, since at this moment either the voltage at the switching element (ZVS) or the current through the switching element (ZCS) is zero.

These resonant topologies are also very successful commercially, whether in the form of charging devices, televisions, photovoltaics, etc. They are almost always transformer converters, which are often configured as flyback or LLC half-bridges with a plurality of switches. These topologies are often also suitable for the use of synchronous rectifiers, e.g., MOSFETs instead of diodes, for further loss optimization.

In light control units in particular, however, there is interest in simpler, transformer-free boost and buck topologies.

An example of a ZVS boost converter is known from https://www.researchgate.net/publication/224343532_Digitally_controlled_ZVS_qua si-resonant_boost_converter_with_M-type_switch. With the addition of two reactances, the choke Lr and the capacitor Cr, so-called M-type switches are synthesized, which (with suitable time control) lead to the voltage at the boost switch at (or shortly before) the moment of switching on being zero.

A further example of such a ZVS boost converter is considered in the following book:
Resonant Power Converters, 2nd Edition, by Marian K. Kazimierczuk and Dariusz Czarkowski. ISBN: 978-0-470-90538-8 Apr. 2011, 640 Pages, p. 489

It should be noted that the converters mentioned above use a diode as a rectifier. The potential use of a transistor switch instead of a diode for power loss optimization fails due to the fact the typical half-bridge driver ICs normally used for this purpose would not function at all in this resonant arrangement due to the voltage at the choke Lr. These half-bridge driver ICs typically have a bootstrap circuit for the high-side gate driver, which requires a fixed drain-source connection of the half-bridge FETs to function properly and thus operate the upper FET as a synchronized rectifier. With the choke Lr and the resonant voltage built thereon, the classic half-bridges cannot function; see
“Hard-switching synchronous boost converter with half-bridge driver IC”. Source: https://epc-co.com/epc/Portals/0/epc/documents/application-notes/How2AppNote023%20How%20to%20Design%20a%2012%20V-to-60%20V%20Boost%20Converter.pdf?ver=VEk5bu4gx2INMsA3rbIDig%3d%3d

In WO 2019/192234 A1, the potential use of a synchronous rectifier (S3) is suggested, but without a concrete explanation of how this should be implemented.

The ZVS boost topologies with M-switches mentioned above can be represented in generalized form, as shown in FIG. 1, with Dsync or Qsync as the rectifier in the general illustration. A simulation result of this circuit with a diode Dsync (and the body diode of the FET rectifier Qsync, GH is inactive) is represented in FIG. 2 and shows the characteristic current/voltage curves; in the downtime (V(gl) to low) the voltage V(res) at the drain terminal of the switch Qbst oscillates in a sinusoidal shape and comes to zero shortly before the switch Qbst is switched on again.

Similarly, a ZVS buck converter with a resonant M-switch can also come into consideration for implementing this concept. There are two options for placing the resonant choke Lres: either to the left or right of the M-switch. In the following, these are to be referred to as variant 1 or variant 2.

First, the ZVS buck converter variant 1 with Lres to the left of the switch should be considered, as is known, for example, from https://e-university.tu-sofia.bg/e-publ/files/1493_Paper_Hinov_Rangelov.pdf.

Analogous to the above described ZVS boost converter, the generalized ZVS buck converter variant 1 can be represented with positive resonant voltage V(res), as shown in FIG. 3. The simulation of this circuit (GL is inactive in the simulation, rectification is carried out by the diode Dsync or by the body diode of Qsync) shows, as represented in FIG. 4, that the resonant voltage V(res) at the RES node has a high positive peak value as expected. However, V(res) has a positive DC component equal to the input voltage V(in), and this requires a Qsync control circuit different from that of the ZVS boost converter. V(res) is shown with the lowest curve of FIG. 4.

Now the ZVS buck converter variant 2 with Lres to the right of the switch is taken into consideration, as shown in FIG. 5 and as is known, for example, from
https://e-university.tu-sofia.bg/e-publ/files/1493_Paper_Hinov_Rangelov.pdf.

The simulation of this circuit (GL is inactive in the simulation, rectification is carried out by the diode Dsync or by the body diode of Qsync) shows that the resonant voltage V(res) at the RES node has a high negative peak value as expected. V(res) is shown with the lowest curve of FIG. 6.

There remains an opportunity for DC-DC converters which enable ZVS operation and are designed as simply as possible.

### SUMMARY

In one embodiment, a DC-DC converter includes an input terminal and an output terminal. An accumulator coil and a synchronous rectifier transistor are connected in series via a first connection terminal and connected between the input terminal and the output terminal. A resonant coil and a storage transistor are connected in series via a second connection terminal and connected between the first connection terminal and a reference potential. The storage transistor is connected in parallel with a resonant capacitor. A first reverse-biased diode is connected between the first connection terminal and the reference potential. A series circuit including a first voltage divider resistor and a first capacitor is connected between the second connection terminal and a control terminal of the synchronous rectifier transistor. A second voltage divider resistor is connected between the control terminal of the synchronous rectifier transistor and the first connection terminal.

The resonant voltage at the second connection terminal, the resonant node, is the highest voltage in the converter system. Therefore, instead of a rectifier diode, an N-MOSFET is used as a synchronous rectifier, the source terminal of which is connected to the first connection node SW and by a suitable circuit consisting of resistors and a capacitor from the high resonant voltage, a suitable gate control voltage is prepared, which can control the FET rectifier in the phases in which the storage transistor is off, as a synchronous rectifier.

In another embodiment, a DC-DC converter includes an input terminal and an output terminal. A resonant coil and a storage transistor connected are in series via a second connection terminal and connected between the input terminal and a first connection terminal. The storage transistor is connected in parallel with a resonant capacitor. An accumulator coil is connected between the first connection terminal and the output terminal. A synchronous rectifier transistor is connected between the first connection terminal and a reference potential. A first reverse-biased diode is connected between the input terminal and the first connection terminal. A series circuit including the load path of a first pnp-bipolar transistor, a first voltage divider resistor, and a first capacitor is connected between the second connection terminal and a control terminal of the synchronous rectifier transistor. A second voltage divider resistor is connected between the control terminal of the synchronous rectifier transistor and the reference potential. A series circuit including a third voltage divider resistor and a fourth voltage divider resistor is connected parallel to the resonant coil, the connection point of the series circuit being connected to the base terminal of the first pnp-bipolar transistor.

In yet another embodiment, a DC-DC converter includes an input terminal and an output terminal. A storage transistor and a resonant coil are connected in series via a second connection terminal and connected between the input terminal and a first connection terminal. The storage transistor is connected in parallel with a resonant capacitor. An accumulator coil is connected between the first connection terminal and the output terminal. A synchronous rectifier transistor is connected between the first connection terminal and a reference potential. A first reverse-biased diode is connected between the input terminal and the first connection terminal. A series circuit including a first voltage divider resistor and a first capacitor is connected between the second connection terminal and a control terminal of the synchronous rectifier transistor. A second voltage divider resistor is connected between the control terminal of the synchronous rectifier transistor and the first connection terminal.

In a further development of the boost DC-DC converter or the buck DC-DC converter described above, the second voltage divider resistor is connected in parallel with a Zener diode, the cathode of which is connected to the control terminal of the synchronous rectifier transistor.

Accordingly, in the buck DC-DC converter the second voltage divider resistor may be connected in parallel with a Zener diode, the anode of which is connected to the control terminal of the synchronous rectifier transistor.

In the boost DC-DC converter, the first voltage divider resistor may be formed with a first resistor and a second resistor, between which the first capacitor is arranged, wherein the load path of a pnp-bipolar transistor is connected between the control terminal of the synchronous rectifier transistor and the first connection terminal, and wherein the second resistor is arranged between the emitter terminal and the base terminal of the pnp-bipolar transistor.

In one buck DC-DC converter variant, the first voltage divider resistor may be formed with a first resistor and a second resistor, between which the first capacitor is arranged, wherein the load path of a pnp-bipolar transistor is connected between the control terminal of the synchronous rectifier transistor and the reference potential, and wherein the second resistor is arranged between the emitter terminal and the base terminal of the pnp-bipolar transistor.

In one buck DC-DC converter variant, the first voltage divider resistor may be formed with a first resistor and a second resistor, between which the first capacitor is arranged, wherein the load path of a npn-bipolar transistor is connected between the control terminal of the synchronous rectifier transistor and the first connection terminal, and wherein the second resistor is arranged between the emitter terminal and the base terminal of the npn-bipolar transistor.

Advantages of the DC-DC converter variants described herein and their further developments result from the following description of exemplary embodiments, which are discussed with the aid of figures. Common to these DC-DC converter variants is the fact that a storage transistor, i.e., a transistor that controls the current through the accumulator coil, is connected in series with a resonant coil and in parallel with a resonant capacitor. A FET is used as a synchronous rectifier transistor, the gate terminal of which is connected via a suitable circuit with a resonant node between the resonant capacitor and the resonant coil in order to be switched on at a desired time from the high voltage present there.

### BRIEF DESCRIPTION OF THE FIGURES

In the figures

FIG. 1 shows a boost DC-DC converter according to the prior art,

FIG. 2 shows voltage and current waveforms according to a simulation of the converter according to FIG. 1,

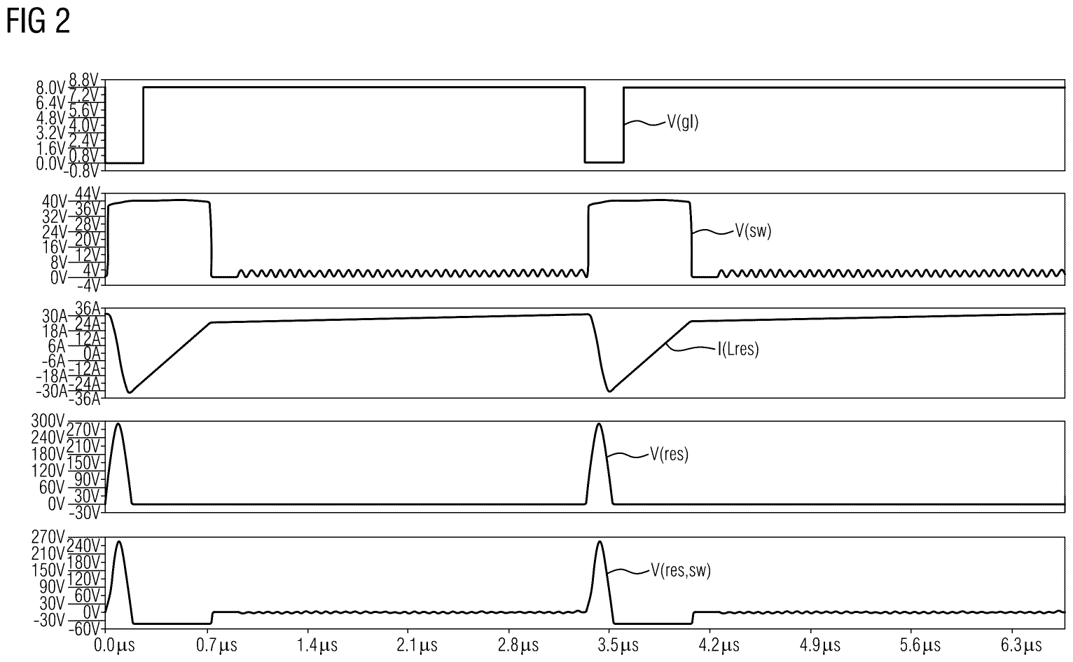

FIG. 3 shows a buck DC-DC converter according to the prior art,

FIG. 4 shows voltage and current waveforms according to a simulation of the converter according to FIG. 3,

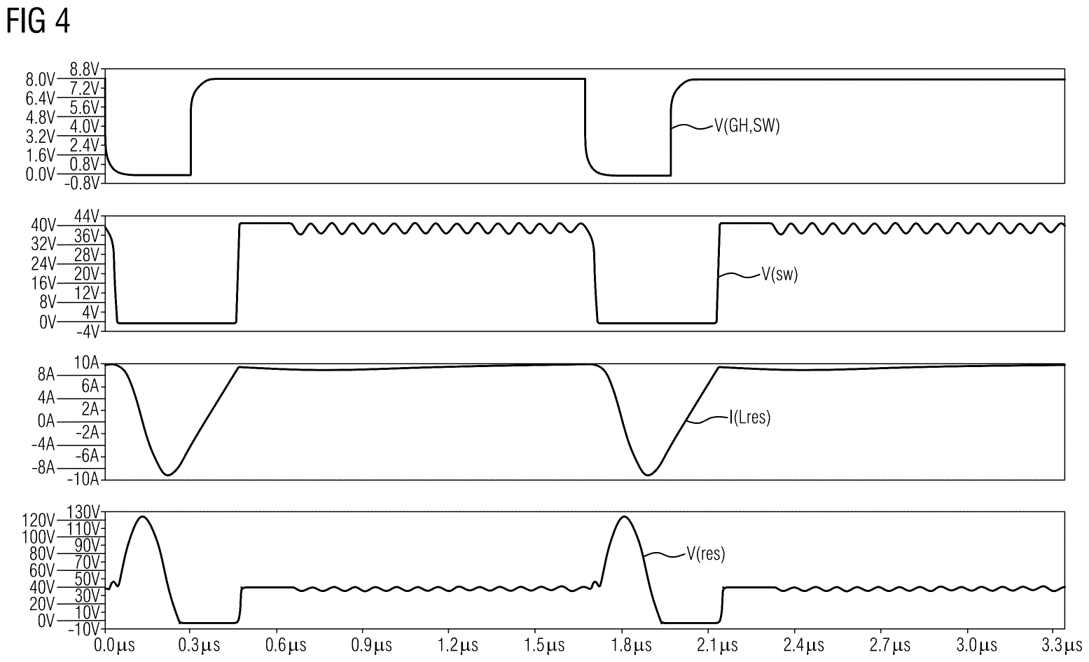

FIG. 5 shows a further buck DC-DC converter according to the prior art,

FIG. 6 shows voltage and current waveforms according to a simulation of the converter according to FIG. 5,

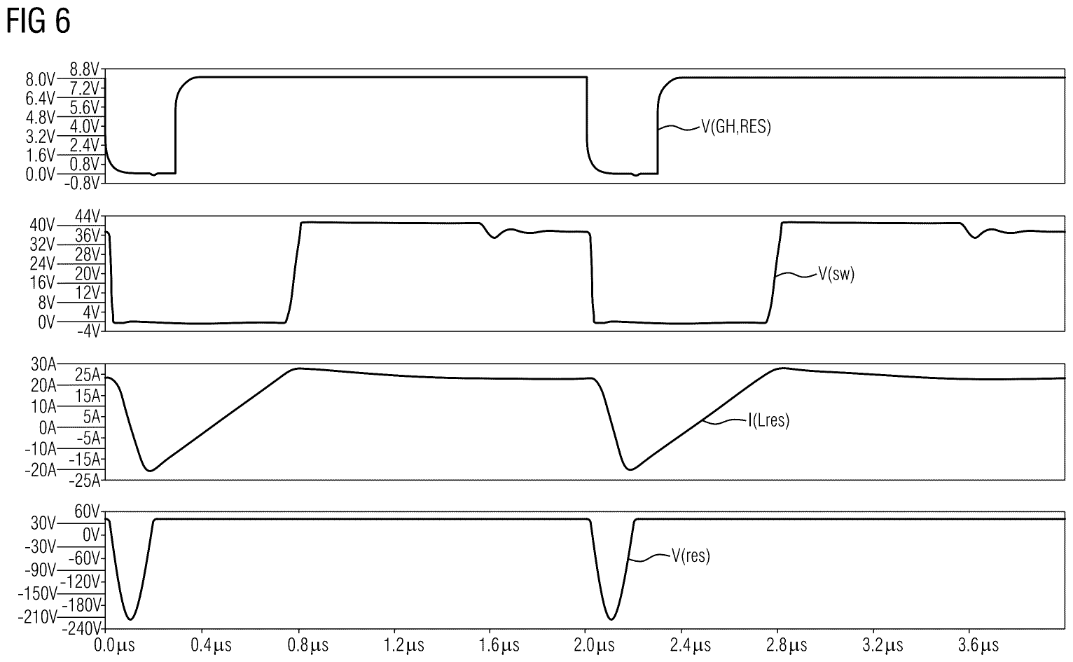

FIG. 7 shows a boost DC-DC converter according to one exemplary embodiment,

FIG. 8 shows voltage and current waveforms according to a simulation of the converter according to FIG. 7,

FIG. 9 shows voltage and current waveforms according to a simulation of the converter according to FIG. 7,

FIG. 10 shows voltage and current waveforms according to a simulation of the converter according to FIG. 7,

FIG. 11 shows voltage and current waveforms according to a simulation of the converter according to FIG. 7,

FIG. 12 shows a buck DC-DC converter according to one exemplary embodiment,

FIG. 13 shows voltage and current waveforms according to a simulation of the converter according to FIG. 12,

FIG. 14 shows voltage and current waveforms according to a simulation of the converter according to FIG. 12,

FIG. 15 shows voltage and current waveforms according to a simulation of the converter according to FIG. 12,

FIG. 16 shows voltage and current waveforms according to a simulation of the converter according to FIG. 12,

FIG. 17 shows a further buck DC-DC converter according to one exemplary embodiment,

FIG. 18 shows voltage and current waveforms according to a simulation of the converter according to FIG. 17,

FIG. 19 shows voltage and current waveforms according to a simulation of the converter according to FIG. 17.

### DETAILED DESCRIPTION

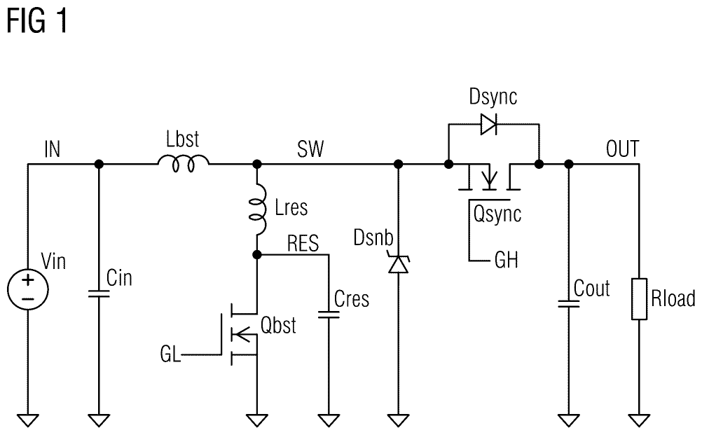

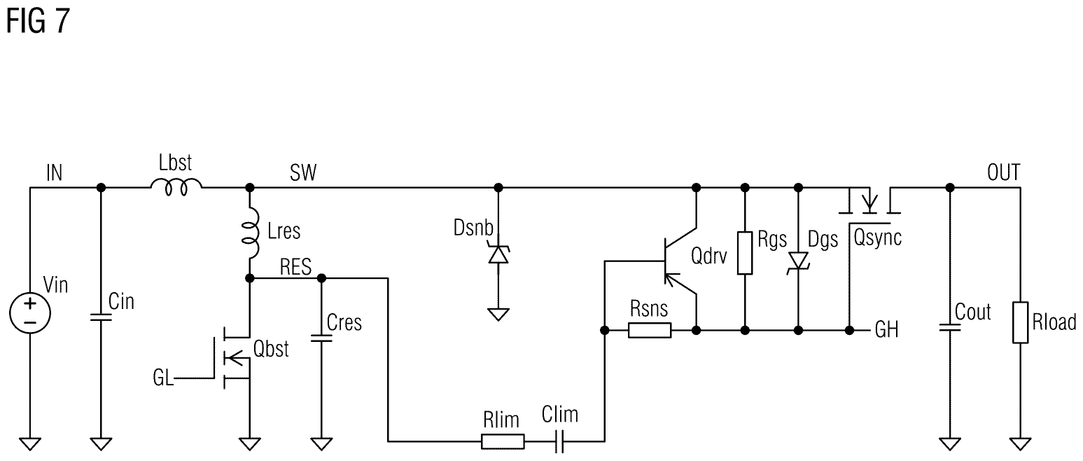

The ZVS boost converter shown in FIG. 7 is based on the boost converter shown in FIG. 1, but has the following additional components, which are connected in series: a first diode Dlim, a first voltage divider resistor Rlim, Rsns, which is formed with a first resistor Rlim and a second resistor Rsn, between which a first capacitor Clim is arranged. A second voltage divider resistor Rgs, a Zener diode Dgs and the load path of a pnp-bipolar transistor Qdrv are arranged between the gate terminal of a synchronous rectifier transistor Qsync and the first connection terminal SW, wherein the second resistor Rsns is arranged between the emitter terminal and the base terminal of the pnp-bipolar transistor Qdrv. The transistor Qdrv can be optionally provided and enables faster switching off of the synchronous rectifier transistor Qsync.

The synchronous rectifier transistor Qsync is an N-MOSFET used as a synchronous rectifier. Its source terminal is located at the floating first connection terminal SW, so it needs a gate voltage higher than the voltage at the first connection terminal SW in order to control it. This is derived from the resonant voltage V(res) at the second connection terminal RES. The first resistor Rlim, together with the impedance of the first capacitor Clim, the second resistor Rsns and the second voltage divider resistor Rgs, determines the voltage division ratio of the voltage V(res) at the second connection terminal RES to the voltage V(gh) at the gate terminal of the synchronous rectifier transistor Qsync and thus the gate-source voltage amplitude for the synchronous rectifier transistor Qsync.

The capacitance of the first capacitor Clim is selected in such a way that the entire gate control circuit operates at the known resonant frequency with as low loss as possible, taking into account the gate charge of the FET used, the resonant frequency, the desired gate voltage amplitude, etc. The pnp-bipolar transistor Qdrv, together with the second resistor Rsns, allows the rapid blocking of the synchronous rectifier transistor Qsync, if this is desired. The Zener diode Dgs protects the gate-source path of the synchronous rectifier transistor Qsync.

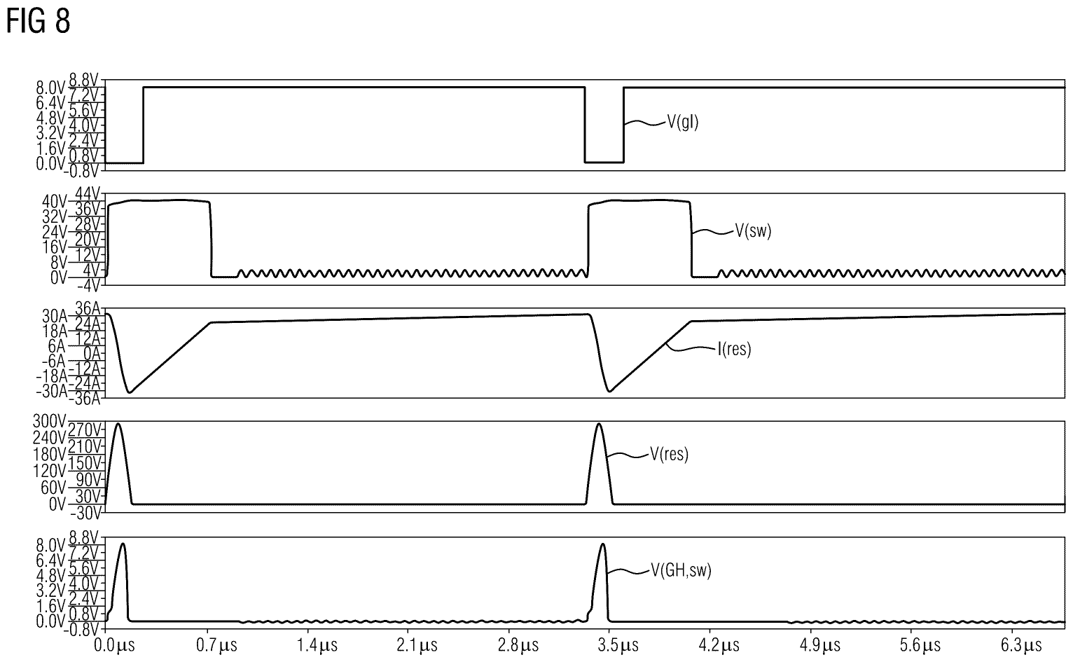

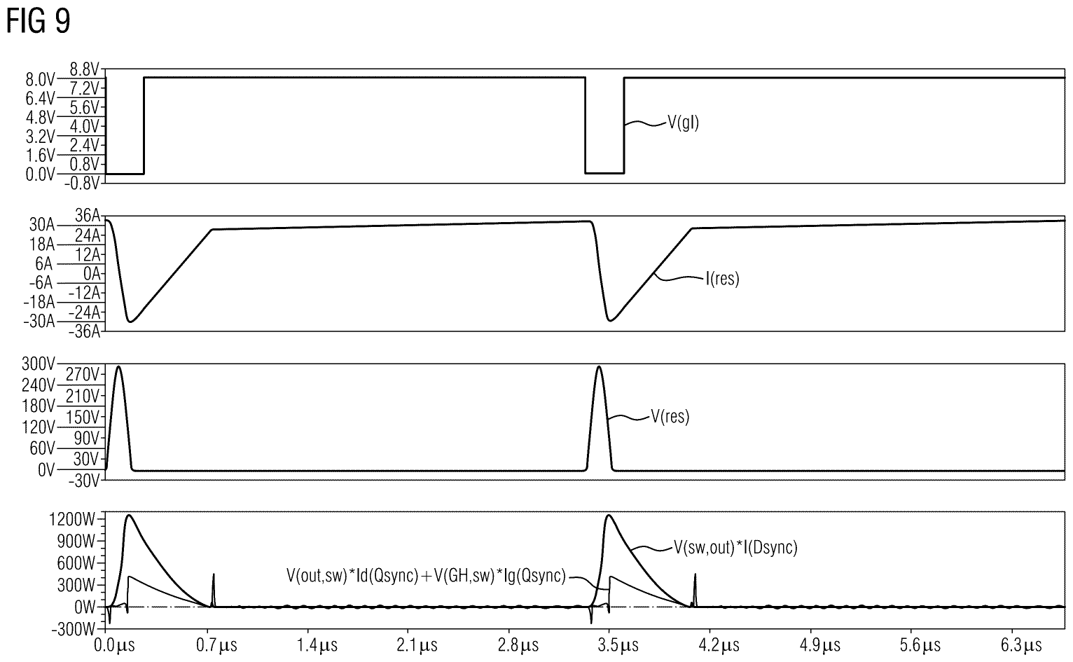

A simulation of the ZVS boost converter with high output power in resonant mode shown in FIG. 7 shows the characteristic current/voltage waveforms as shown in FIGS. 8 to 11. The gate-source voltage of the synchronous rectifier transistor Qsync is shown in the lower waveform in FIG. 9. As can be seen, the amplitude, timing and shape of the control signal is well suited for controlling both logic levels and standard N-MOSFETs in the role of the synchronous rectifier transistor Qsync due to the appropriate selection of the proposed driver components.

This gate voltage differs from the classic rectangular FET control signal, as it is derived from a sinusoidal resonant voltage with few components in a cost-saving manner. The synchronous rectifier transistor Qsync will temporarily operate in linear mode with higher power dissipation. Nevertheless, the solution with such a synchronous FET has substantially lower losses when suitably designed than that with a diode, as also shown in a comparison simulation in FIG. 9.

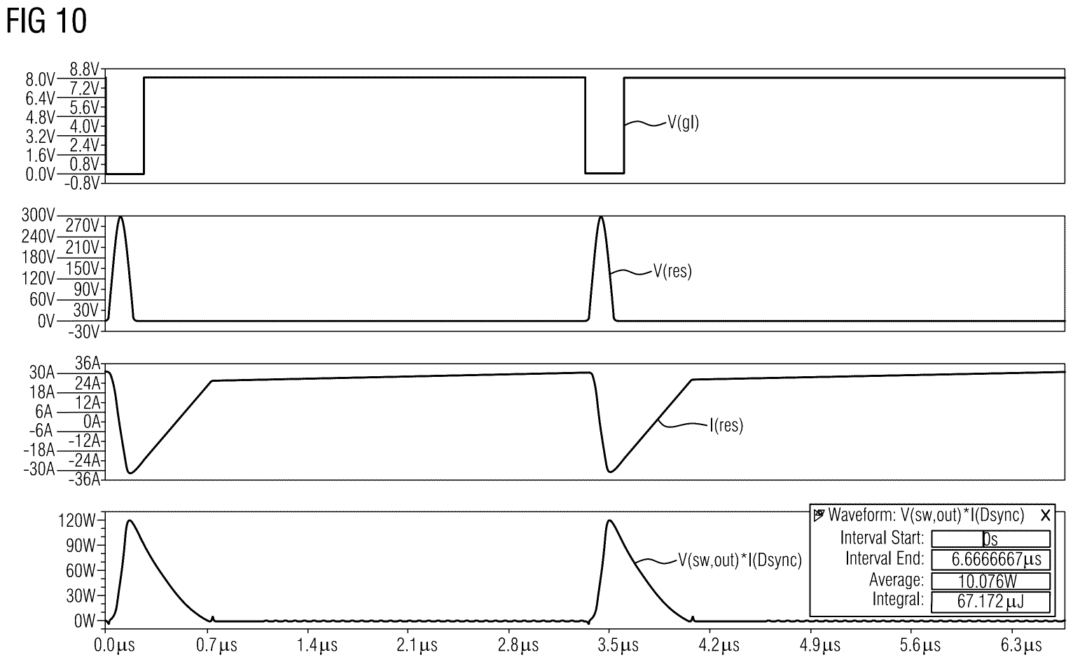

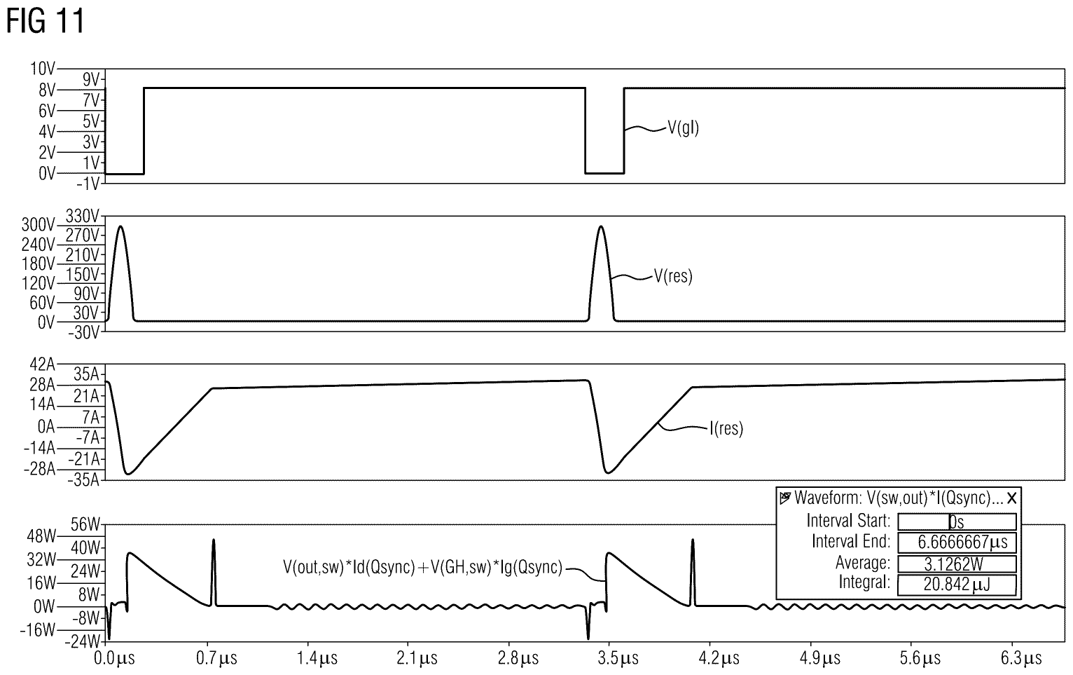

FIGS. 10 and 11 show a comparison simulation. In one case, a suitable Schottky diode Dsync is used as a rectifier (power dissipation in Dsync shown at the bottom of FIG. 10), while in the other case, a suitable NFET with the proposed driver circuit is used as a synchronous rectifier (power dissipation in Qsync shown at the bottom of in FIG. 11). It is immediately apparent that the losses in the FET, controlled by means of the proposed circuit, are much lower than those of the rectifier diode (area below the power loss curve, averaged over a switching period).

A numerical evaluation of the power losses in the comparison simulation described above provides the power losses as follows: losses in Dsync (Schottky diode) −10.1 W, losses in Qsync (low-impedance N-FET) −3.1 W.

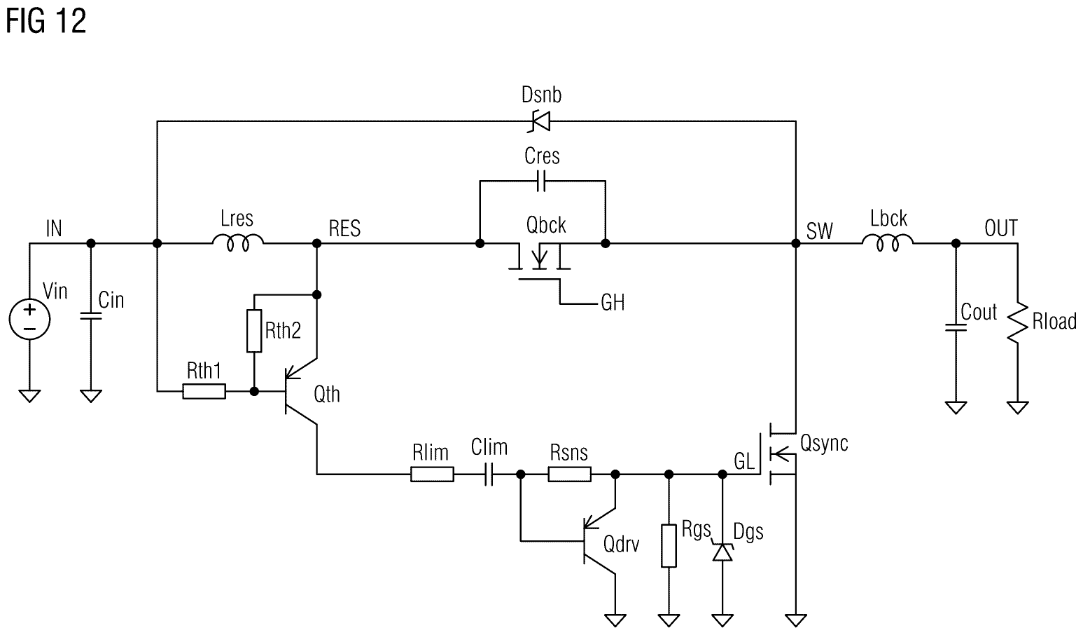

FIG. 12 shows a first variant 1 of a ZVS buck converter with a synchronous FET rectifier and its activation by means of the voltage at the second connection terminal RES via a circuit according to the invention.

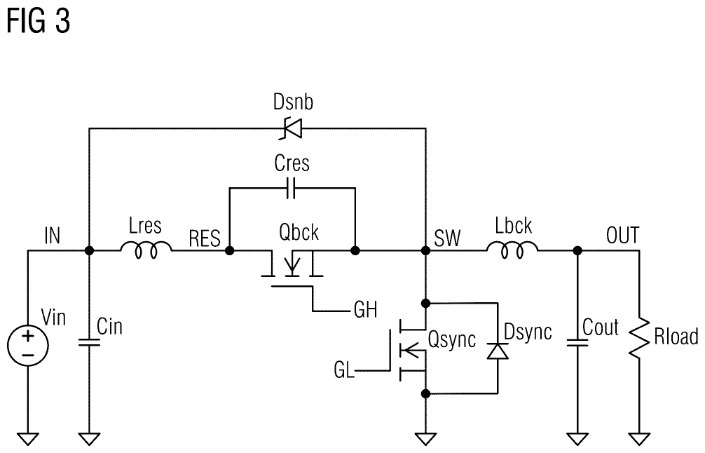

The ZVS buck converter shown (variant 1) is based on the buck converter shown in FIG. 3, but has additional components that enable simple ZVS operation: Rth1, Rrth2, Qth, Rlim, Clim, Rsns, Qdrv, Rgs, Dgs, and Qsync.

A resonant coil Lres and a storage transistor Qbck connected in series via a second connection terminal RES are connected between the input terminal IN and a first connection terminal SW, wherein the storage transistor Qbck is connected in parallel with a resonant capacitor Cres. An accumulator coil Lbck is arranged between the first connection terminal SW and the output terminal OUT and a synchronous rectifier transistor Qsync is arranged between the first connection terminal SW and a reference potential. A first reverse-biased diode Dsnb is connected between the input terminal IN and the first connection terminal SW. Similar to the boost DC-DC converter described above, the series circuit consisting of the load path of a first pnp-bipolar transistor Qth, a first voltage divider resistor Rlim, Rsns and a first capacitor Clim is connected between the second connection terminal RES and a control terminal of the synchronous rectifier transistor Qsync, and a second voltage divider resistor Rgs is connected between the control terminal of the synchronous rectifier transistor Qsync and the reference potential. The series circuit consisting of a third voltage divider resistor Rth1 and a fourth voltage divider resistor Rth2 is connected parallel to the resonant coil Lres, the connection point of the series circuit being connected to the base terminal of the first pnp-bipolar transistor Qth.

The second voltage divider resistor Rgs is connected in parallel with a Zener diode Dgs, the cathode of which is connected to the control terminal of the synchronous rectifier transistor Qsync. The first voltage divider resistor Rlim, Rsns is formed with a first resistor Rlim and a second resistor Rsns, between which the first capacitor Clim is arranged, wherein the load path of a pnp-bipolar transistor Qdrv is connected between the control terminal and the reference potential, wherein the second resistor Rsns is arranged between the emitter terminal and the base terminal of the pnp-bipolar transistor Qdrv. The transistor Qdrv enables faster switching off of the synchronous rectifier transistor Qsync and can only be optionally provided.

The components shown and described here have the same function as described above for the boost converter, which shall therefore not be repeated. It is essential that the high voltage at the second connection terminal RES is used to synchronize the synchronous rectifier transistor Qsync in order to enable ZVS operation.

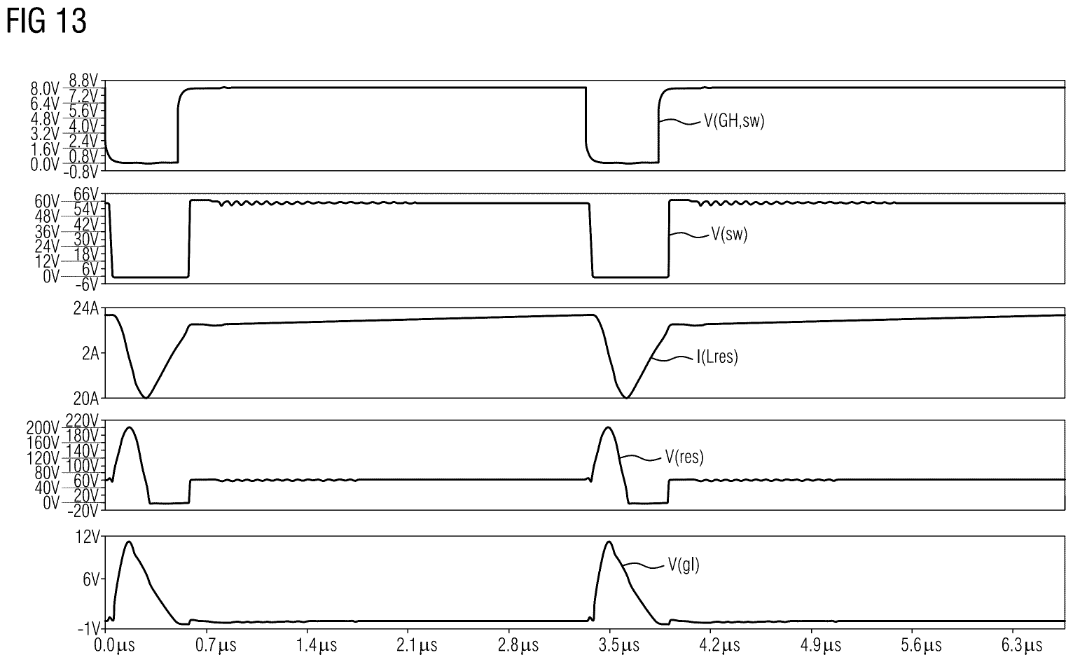

A simulation of the proposed ZVS buck converter (variant 1) with high output power in resonant mode is shown in the characteristic current/voltage waveforms of FIG. 13. The gate source voltage of the synchronous rectifier transistor Qsync is shown in the lower curve. As can be seen, the amplitude, timing and shape of the control signal is well suited for controlling both logic levels and standard N-MOSFETs in the role of the synchronous rectifier transistor Qsync due to the appropriate selection of the proposed driver components.

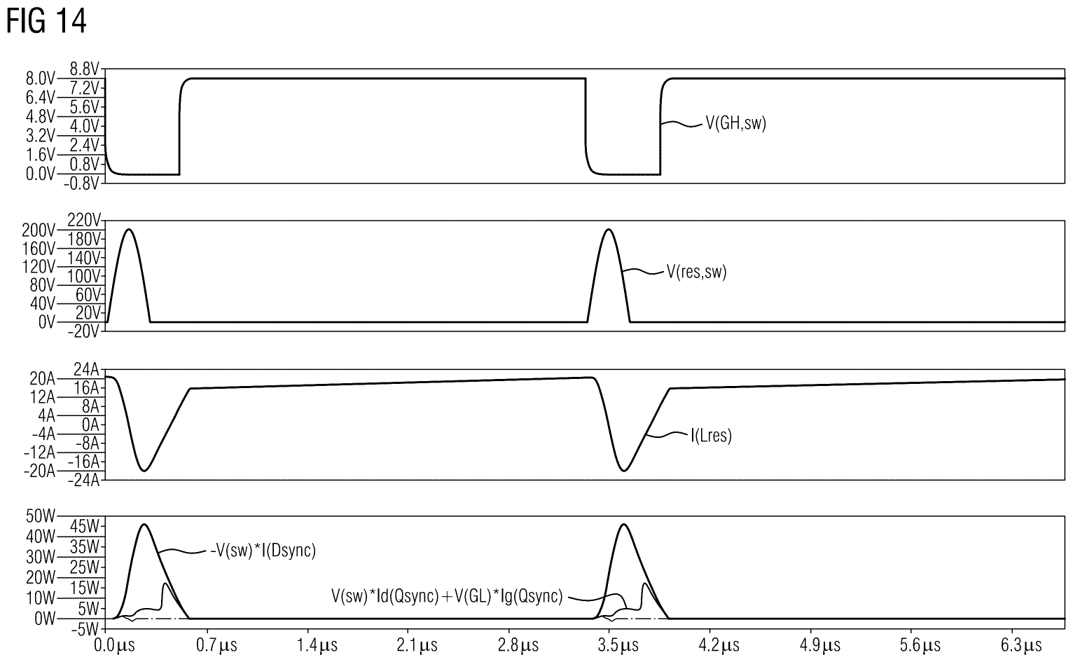

FIG. 14 again shows a comparison simulation. In one case, a suitable Schottky diode Dsync is used as a rectifier (power dissipation in Dsync), while in the other case, a suitable N-channel FET with the proposed driver circuit is used as a synchronous rectifier (power dissipation in Qsync). It is immediately apparent that the losses in the FET, controlled by means of the proposed circuit, are much lower than those of the rectifier diode (area below the power loss curve, averaged over a switching period).

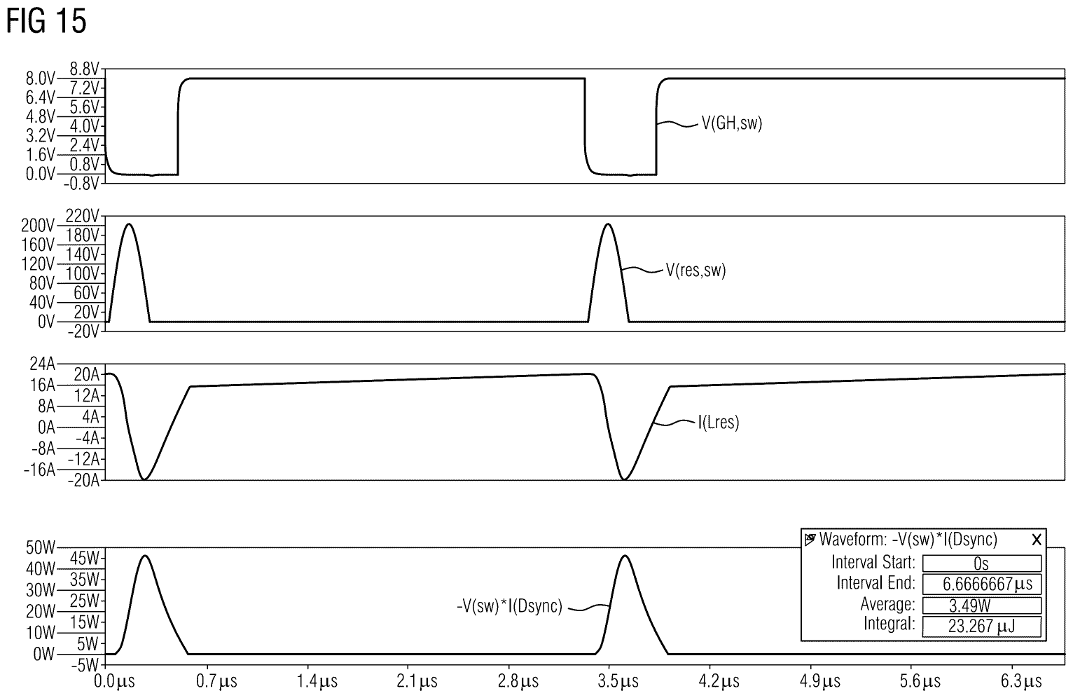

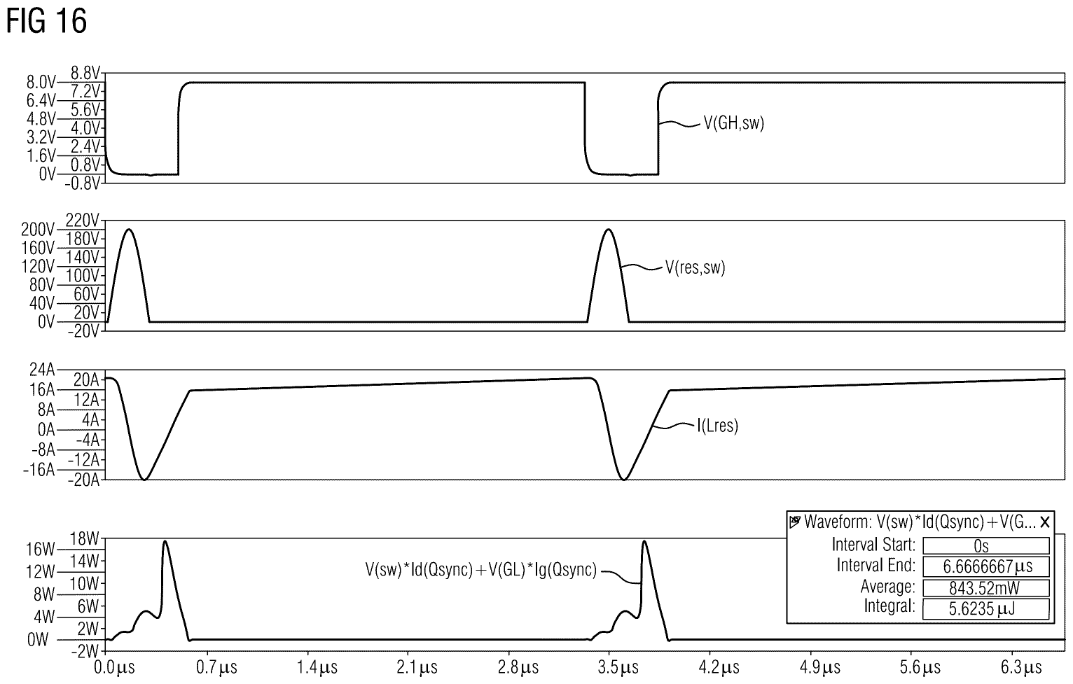

As can be seen from the signal waveforms of the simulations shown in FIGS. 15 and 16, the proposed synchronous rectifier solution has losses of only 0.84 W in the FET Qsync, while the classic diode solution reaches 3.49 W under exactly the same conditions.

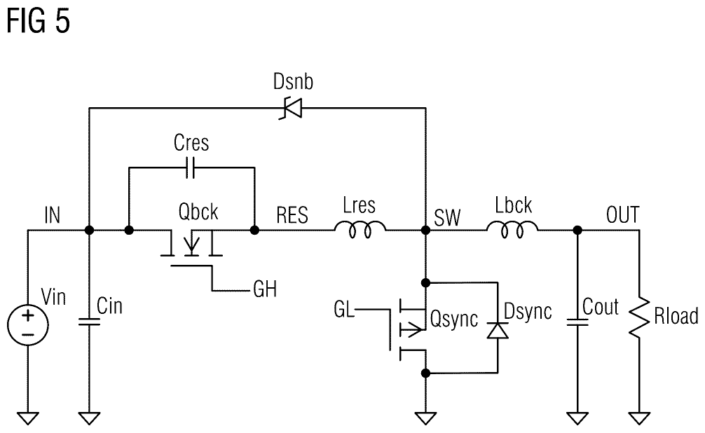

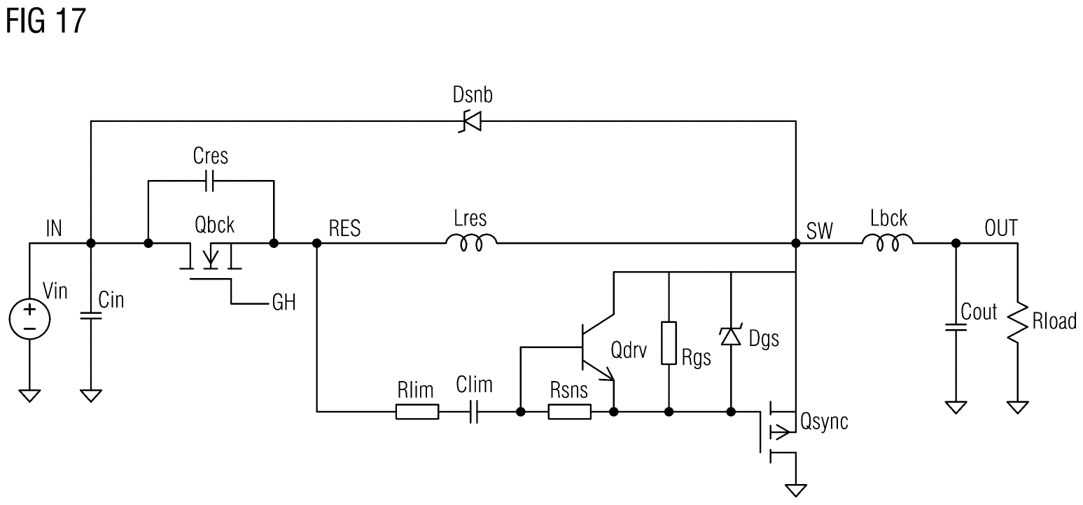

The ZVS-buck-converter shown in FIG. 17 in a second variant is based on the buck-converter shown in FIG. 5, but has—as with the variants already described above—the following additional components: Dlim, Rlim, Clim, Rsns, Qdrv, Rgs, Dgs und Qsync.

Qsync is a P-MOSFET used as a synchronous rectifier. Its source terminal is located at the first connection terminal SW, so it needs a gate voltage lower than its threshold voltage in order to control it. This is derived from the resonant voltage V(res) at the second connection terminal RES. The resistor Rlim, together with the impedance of the capacitor Clim and the resistors Rsns and Rgs, determines the voltage division ratio of V(res) to V(gh) and thus the gate source voltage amplitude for the synchronous rectifier transistor Qsync. The capacitor Clim is selected in such a way that the entire gate control circuit operates at the known resonant frequency with as low loss as possible, taking into account the gate charge of the FET used, the resonant frequency, the desired gate voltage amplitude, etc. The transistor Qdrv, together with the resistor Rsns, allows the rapid blocking of the synchronous rectifier transistor Qsync, if this is desired. The Zener diode Dgs protects the gate-source path of the synchronous rectifier transistor Qsync.

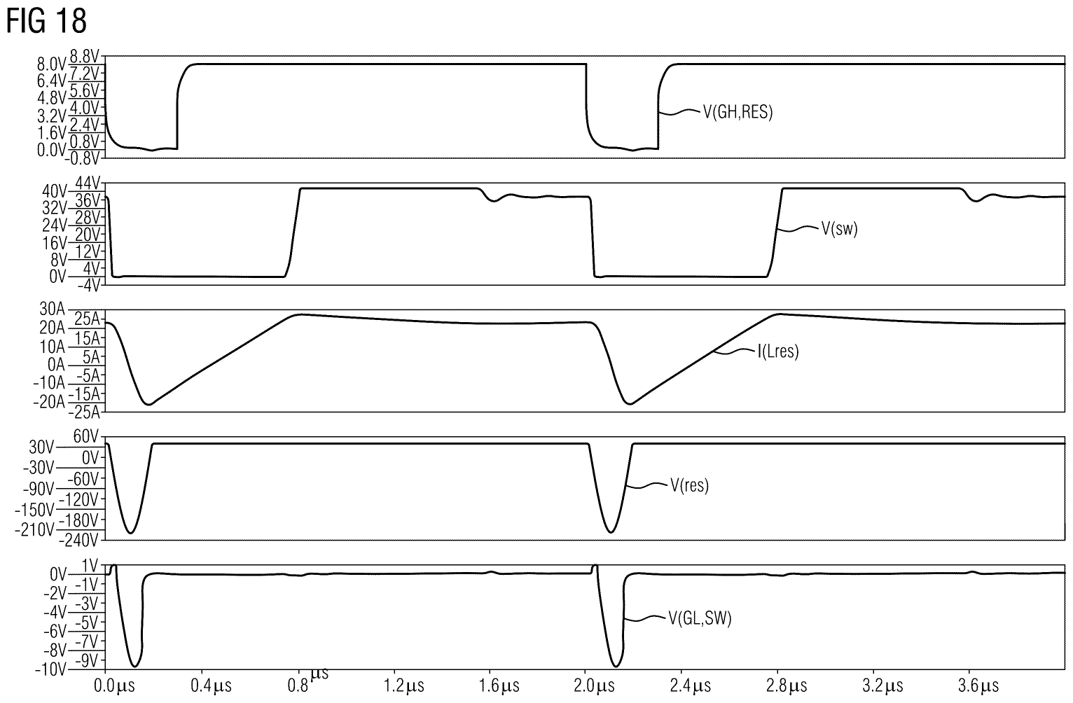

A simulation of the proposed ZVS buck converter (variant 2) with high output power in resonant mode is shown in the characteristic current/voltage waveforms in FIG. 18. The gate source voltage of the synchronous rectifier transistor Qsync is shown in the lower diagram. As can be seen, the amplitude, timing and shape of the control signal is well suited for controlling both a logic level and a standard P-MOSFET in the role of the synchronous rectifier transistor Qsync due to the appropriate selection of the proposed driver components. This differs from the classic rectangular FET control signal, as it is derived from a sinusoidal resonant voltage with few components in a cost-saving manner. It is obvious that the synchronous FET will temporarily operate in linear mode with higher power dissipation. Nevertheless, the solution with a synchronous FET has substantially lower losses than that with a diode, as a comparison simulation will explain.

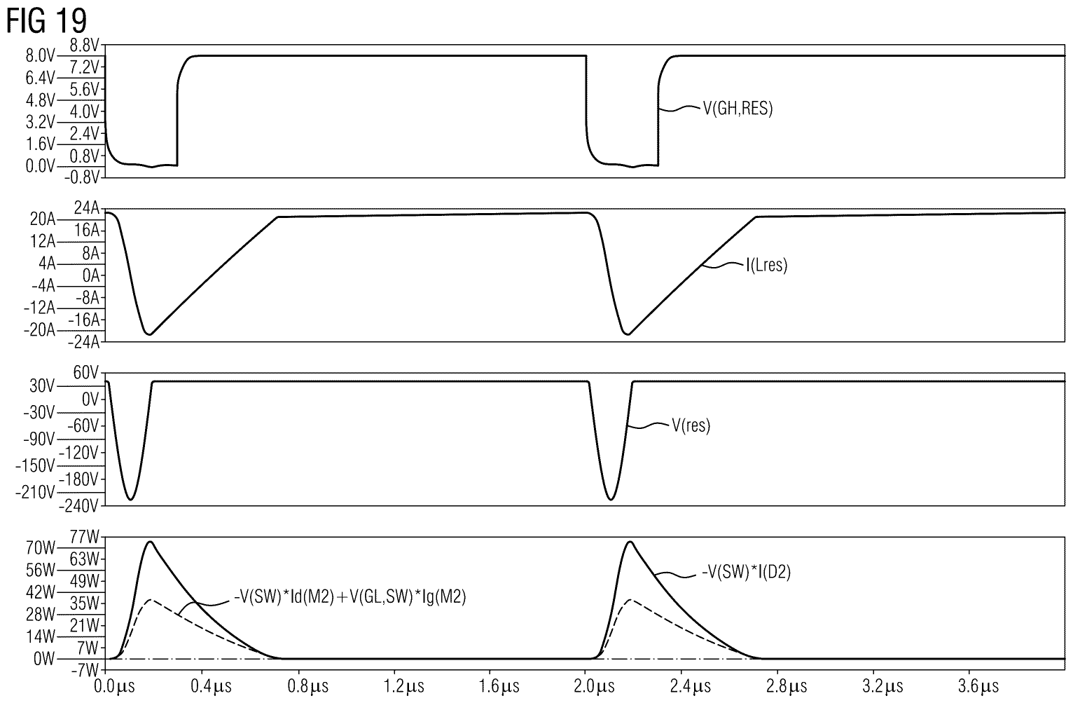

A comparison simulation is shown in FIG. 19. In one case, a suitable Dsync Schottky diode is used as a rectifier (power dissipation in Dsync shown in black at the bottom), while in the other case a suitable PFET with the proposed driver circuit is used as a synchronous rectifier (power dissipation in Qsync). It is immediately apparent that the losses in the FET, controlled by means of the proposed circuit, are much lower than those of the rectifier diode (area below the power loss curve, averaged over a switching period).

The proposed solutions for synchronous rectification in resonant converters exploit the fact that in a resonant converter of the types considered with the so-called “M-type switch”, the resonant voltage is the highest or the lowest (depending on the type of converter) in the system.

The following advantages are thus achieved:
suitable for ZVS boost and ZVS buck converters
the same concept—to control the synchronous rectifier by a signal derived from the resonant voltage—can be extended to all galvanically non-isolated ZVS converters. These include, for example, ZVS buck-boost, Cuk, SEPIC, Zeta etc converters
even ZVS converters with transformers, such as ZVS flybacks, can be implemented under certain circumstances, as long as they do not have to be operated in an electrically isolated manner
conventional high-side gate driver ICs often cannot work properly with ZVS topologies, as they almost always use a bootstrap circuit that sits on the switching node in order to build up voltage for high-side FET driving. If the resonant choke is connected between the switching node and the source, as required by the ZVS topology, the bootstrap circuit can often not function properly or the maximum permissible voltage values of the IC are exceeded
highly cost-effective (few components, no dedicated gate driver LCS)
reliable (the resonant voltage is always present)
no synchronization, no dead times necessary (the resonant voltage is automatically always in the correct phase relative to the control voltage for the main switch)
low EMC interference (the synchronous FET rectifier is actuated with sinusoidal gate voltage and not with rectangular gate voltage and uses “soft” switching)

1. A DC-DC converter comprising:
an input terminal and an output terminal;
an accumulator coil and a synchronous rectifier transistor are connected in series via a first connection terminal and connected between the input terminal and the output terminal;
a resonant coil and a storage transistor connected in series via a second connection terminal and connected between the first connection terminal and a reference potential, wherein the storage transistor is connected in parallel with a resonant capacitor;
a first reverse-biased diode connected between the first connection terminal and the reference potential;
a series circuit including a first voltage divider resistor and a first capacitor is connected between the second connection terminal and a control terminal of the synchronous rectifier transistor, and a second voltage divider resistor is connected between the control terminal of the synchronous rectifier transistor and the first connection terminal.

2. The DC-DC converter as set forth in claim 1, wherein the second voltage divider resistor is connected in parallel with a Zener diode, the cathode of which is connected to the control terminal of the synchronous rectifier transistor.

3. The DC-DC converter as set forth in claim 2, wherein the first voltage divider resistor is formed with a first resistor and a second resistor, between which the first capacitor is arranged, and that the load path of a pnp-bipolar transistor is connected between the control terminal of the synchronous rectifier transistor and the first connection terminal, wherein the second resistor is arranged between the emitter terminal and the base terminal of the pnp-bipolar transistor.

4. The DC-DC converter as set forth in claim 1, wherein the first voltage divider resistor is formed with a first resistor and a second resistor, between which the first capacitor is arranged, and that the load path of a pnp-bipolar transistor is connected between the control terminal of the synchronous rectifier transistor and the first connection terminal, wherein the second resistor is arranged between the emitter terminal and the base terminal of the pnp-bipolar transistor.

5. A DC-DC converter having an input terminal and an output terminal,
wherein a resonant coil and a storage transistor connected in series via a second connection terminal are connected between the input terminal and a first connection terminal, wherein the storage transistor is connected in parallel with a resonant capacitor,
wherein an accumulator coil is connected between the first connection terminal and the output terminal,
wherein a synchronous rectifier transistor is connected between the first connection terminal and a reference potential,
wherein a first reverse-biased diode is connected between the input terminal and the first connection terminal,
wherein a series circuit consisting of the load path of a first pnp-bipolar transistor, a first voltage divider resistor and a first capacitor is connected between the second connection terminal and a control terminal of the synchronous rectifier transistor, and a second voltage divider resistor is connected between the control terminal of the synchronous rectifier transistor and the reference potential,
and that the series circuit consisting of a third voltage divider resistor and a fourth voltage divider resistor is connected in parallel with the resonant coil, the connection point of the series circuit being connected to the base terminal of the first pnp-bipolar transistor.

6. The DC-DC converter as set forth in claim 5, wherein the second voltage divider resistor is connected in parallel with a Zener diode, the cathode of which is connected to the control terminal of the synchronous rectifier transistor.

7. The DC-DC converter as set forth in claim 6, wherein the first voltage divider resistor is formed with a first resistor and a second resistor, between which the first capacitor is arranged, and that the load path of a pnp-bipolar transistor is connected between the control terminal of the synchronous rectifier transistor and the reference potential, wherein the second resistor is arranged between the emitter terminal and the base terminal of the pnp-bipolar transistor.

8. The DC-DC converter as set forth in claim 5, wherein the first voltage divider resistor is formed with a first resistor and a second resistor, between which the first capacitor is arranged, and that the load path of a pnp-bipolar transistor is connected between the control terminal of the synchronous rectifier transistor and the reference potential, wherein the second resistor is arranged between the emitter terminal and the base terminal of the pnp-bipolar transistor.

9. A DC-DC converter having an input terminal and an output terminal, comprising
a storage transistor and a resonant coil connected in series via a second connection terminal are connected between the input terminal and a first connection terminal, wherein the storage transistor is connected in parallel with a resonant capacitor;
an accumulator coil is connected between the first connection terminal and the output terminal;
a synchronous rectifier transistor connected between the first connection terminal and a reference potential;
a first reverse-biased diode is connected between the input terminal and the first connection terminal; and
a series circuit consisting of a first voltage divider resistor and a first capacitor is connected between the second connection terminal and a control terminal of the synchronous rectifier transistor, and a second voltage divider resistor is connected between the control terminal of the synchronous rectifier transistor and the first connection terminal.

10. The DC-DC converter as set forth in claim 9, wherein the second voltage divider resistor is connected in parallel with a Zener diode, the anode of which is connected to the control terminal of the synchronous rectifier transistor.

11. The DC-DC converter as set forth in claim 10, wherein the first voltage divider resistor is formed with a first resistor and a second resistor, between which the first capacitor is arranged, and that the load path of a npn-bipolar transistor is connected between the control terminal of the synchronous rectifier transistor and the first connection terminal, wherein the second resistor is arranged between the emitter terminal and the base terminal of the npn-bipolar transistor.
